(19) United States
(12) Patent Application Publication
(10) Pub. No.: US 2012/0158401 A1
(43) Pub. Date: Jun. 21, 2012

(54) MUSIC DETECTION USING SPECTRAL PEAK ANALYSIS

(75) Inventors: Ivan Leonidovich Mazurenko, Khimki (RU); Dmitry Nikolaevich Babin, Moscow (RU); Alexander Markovic, Media, PA (US); Denis Vladimirovich Parkhomenko, Moscow (RU); Alexander Alexandrovich Petyushko, Bryansk (RU)

(73) Assignee: LSI Corporation, Milpitas, CA (US)

(21) Appl. No.: 13/205,882

(22) Filed: Aug. 9, 2011

(30) Foreign Application Priority Data
Dec. 20, 2010 (RU) 2010152225

(51) Int. Cl. G10L 11/06

(52) U.S. Cl. 704/208; 704/E11.007

(57) ABSTRACT

In one embodiment, a music detection (MD) module accumulates sets of one or more frames and performs FFT processing on each set to recover a set of coefficients, each corresponding to a different frequency k. For each frame, the module identifies candidate musical tones by searching for peak values in the set of coefficients. If a coefficient corresponds to a peak, then a variable TONE[k] corresponding to the coefficient is set equal to one. Otherwise, the variable is set equal to zero. For each variable TONE[k] having a value of one, a corresponding accumulator A[k] is increased. Candidate musical tones that are short in duration are filtered out by comparing each accumulator A[k] to a minimum duration threshold. A determination is made as to whether or not music is present based on a number of candidate musical tones and a sum of candidate musical tone durations using a state machine.

### CROSS-REFERENCE TO RELATED APPLICATIONS

The subject matter of this application is related to Russian patent application no. TBD filed as attorney docket no. L09-0721RU1 on the same day as this application, the teachings of which are incorporated herein by reference in their entirety.

### BACKGROUND OF THE INVENTION

1. Field of the Invention

The present invention relates to signal processing, and, more specifically but not exclusively, to techniques for detecting music in an acoustical signal.

2. Description of the Related Art

Music detection techniques that differentiate music from other sounds such as speech and noise are used in a number of different applications. For example, music detection is used in sound encoding and decoding systems to select between two or more different encoding schemes based on the presence or absence of music. Signals containing speech, without music, may be encoded at lower bit rates (e.g., 8 kb/s) to minimize bandwidth without sacrificing quality of the signal. Signals containing music, on the other hand, typically require higher bit rates (e.g., >8 kb/s) to achieve the same level of quality as that of signals containing speech without music. To minimize bandwidth when speech is present without music, the encoding system may be selectively configured to encode the signal at a lower bit rate. When music is detected, the encoding system may be selectively configured to encode the signal at a higher bit rate to achieve a satisfactory level of quality. Further, in some implementations, the encoding system may be selectively configured to switch between two or more different encoding algorithms based on the presence or absence of music. A discussion of the use of music detection in sound encoding systems may be found, for example, in U.S. Pat. No. 6,697,776, the teachings of which are incorporated herein by reference in their entirety.

As another example, music detection techniques may be used in video handling and storage applications. A discussion of the use of music detection in video handling and storage applications may be found, for example, in Minami, et al., “Video Handling with Music and Speech Detection,” IEEE Multimedia, Vol. 5, Issue 3, pgs. 17-25, July-September 1998, the teachings of which are incorporated herein by reference in their entirety.

As yet another example, music detection techniques may be used in public switched telephone networks (PSTNs) to prevent echo cancellers from corrupting music signals. When a consumer speaks from a far end of the network, the speech may be reflected from a line hybrid at the near end, and an output signal containing echo may be returned from the near end of the network to the far end. Typically, the echo canceller will model the echo and cancel the echo by subtracting the modeled echo from the output signal.

If the consumer is speaking at the far end of the network while music-on-hold is playing from the near end of the network, then the echo and music are mixed producing a mixed output signal. However, rather than cancelling the echo, in some cases, the non-linear processing module of the echo canceller suppresses the echo by clipping the mixed output signal and replaces fragments of the mixed output signal with comfort noise. As a result of this improper and unexpected echo canceller operation, instead of music, the consumer may hear intervals of silence and noise while the consumer is speaking into the handset. In such a case, the consumer may assume that the line is broken and terminate the call.

To prevent this scenario from occurring, music detection techniques may be used to detect when music is present, and, when music is present, the non-linear processing module of the echo canceller may be switched off. As a result, echo will remain in the mixed output signal; however, the existence of echo will typically sound more natural than the clipped mixed output signal. A discussion of the use of music detection techniques in PSTN applications may be found, for example, in Avi Perry, “Fundamentals of Voice-Quality Engineering in Wireless Networks,” Cambridge University Press, 2006, the teachings of which are incorporated herein by reference in their entirety.

A number of different music detection techniques currently exist. In general, the existing techniques analyze tones in the received signal to determine whether or not music is present. Most, if not all, of these tone-based music detection techniques may be separated into two basic categories: (i) stochastic model-based techniques and (ii) deterministic model-based techniques. A discussion of stochastic model-based techniques may be found in, for example, Compure Company, “Music and Speech Detection System Based on Hidden Markov Models and Gaussian Mixture Models,” a Public White Paper, http://www.compure.com, the teachings of which are incorporated herein by reference in their entirety. A discussion of deterministic model-based techniques may be found, for example, in U.S. Pat. No. 7,130,795, the teachings of which are incorporated herein by reference in their entirety.

Stochastic model-based techniques, which include Hidden Markov models, Gaussian mixture models, and Bayesian rules, are relatively computationally complex, and as a result, are difficult to use in real-time applications like PSTN applications. Deterministic model-based techniques, which include threshold methods, are less computationally complex than stochastic model-based techniques, but typically have higher detection error rates. Music detection techniques are needed that are (i) not as computationally complex as Stochastic model-based techniques, (ii) more accurate than deterministic model-based techniques, and (iii) capable of being used in real-time low-latency processing applications such as PSTN applications.

### SUMMARY OF THE INVENTION

In one embodiment, the present invention is a processor-implemented method for processing audio signals to determine whether or not the audio signals correspond to music. According to the method, a plurality of tones are identified corresponding to long-duration spectral peaks in a received audio signal (e.g., Sin). A value is generated for a first metric based on number of the identified tones, and a value is generated for a second metric based on duration of the identified tones. A determination is as to whether or not the received audio signal corresponds to music based on the first and second metric values.

In another embodiment, the present invention is an apparatus comprising a processor for processing audio signals to determine whether or not the audio signals correspond to music. The processor is adapted to identify a plurality of tones corresponding to long-duration spectral peaks in a received audio signal. The processor is further adapted to generate a value for a first metric based on number of the identified tones, and a value for a second metric based on duration of the identified tones. The processor is yet further adapted to determine whether or not the received audio signal corresponds to music based on the first and second metric values.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a simplified block diagram of a near end of a public switched telephone network (PSTN) according to one embodiment of the present invention;

FIG. 2 shows a simplified flow diagram according to one embodiment of the present invention of processing performed by a music detection module;

FIG. 3 shows pseudocode according to one embodiment of the present invention that implements a pre-emphasis technique that may be used by the preprocessing in FIG. 2;

FIG. 4 shows pseudocode according to one embodiment of the present invention that may be used to implement FFT frame normalization;

FIG. 5 shows pseudocode according to one embodiment of the present invention that may be used to implement the exponential smoothing in FIG. 2;

FIG. 6 shows a simplified flow diagram of processing according to one embodiment of the present invention that may be used to implement the candidate musical tone finding operation in FIG. 2;

FIG. 7 shows pseudocode according to one embodiment of the present invention that may be used to update the set of tone accumulators in FIG. 2;

FIG. 8 shows pseudocode according to one embodiment of the present invention that may be used to filter out candidate musical tones that are short in duration;

FIG. 9 shows a simplified state diagram according to one embodiment of the present invention of the finite automaton processing of FIG. 2; and

FIG. 10 shows an exemplary graph used to generate the soft-decision and hard-decision rules used in the state diagram of FIG. 9.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

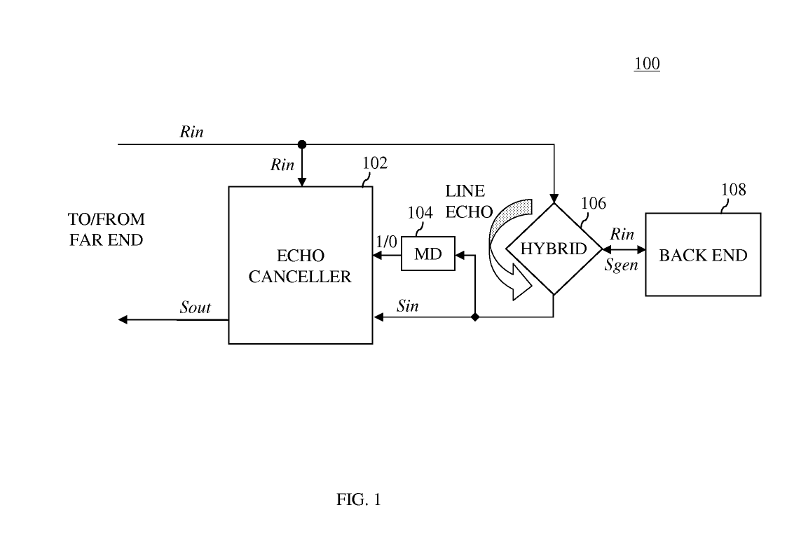

FIG. 1 shows a simplified block diagram of a near end 100 of a public switched telephone network (PSTN) according to one embodiment of the present invention. A first user located at near end 100 communicates with a second user located at a far-end (not shown) of the network. The user at the far end may be, for example, a consumer using a land-line telephone, cell phone, or any other suitable communications device. The user at near end 100 may be, for example, a business that utilizes a music-on-hold system. As depicted in FIG. 1, near end 100 has two communication channels: (1) an upper channel for receiving signal Rᵢₙ generated at the far end of the network and (2) a lower channel for communicating signal Sₒᵤₜ to the far end. The far end may be implemented in a manner similar to that of near end 100, rotated by 180 degrees such that the far end receives signals via the lower channel and communicates signals via the upper channel.

Received signal Rᵢₙ is routed to back end 108 through hybrid 106, which may be implemented as a two-wire-to-four-wire converter that separates the upper and lower channels. Back end 108, which is part of user equipment such as a telephone, may include, among other things, the speaker and microphone of the communications device. Signal S_{gen} generated at the back end 108 is routed through hybrid 106, where unwanted echo may be combined with signal S_{gen} to generate signal Sᵢₙ that has diminished quality. Echo canceller 102 estimates echo in signal Sᵢₙ based on received signal Rᵢₙ and cancels the echo by subtracting the estimated echo from signal Sᵢₙ to generate output signal Sₒᵤₜ, which is provided to the far-end.

When music-on-hold is playing at near end 100 and the far-end user is speaking, the resulting signal Sᵢₙ may comprise both music and echo. As described above in the background, in some conventional public switched telephone networks, rather than cancelling the echo, the non-linear processing module of the echo canceller suppresses the echo by clipping the mixed output signal and replaces the echoed sound fragments with comfort noise. To prevent this from occurring, the non-linear processing module of echo canceller 102 is stopped when music is detected by music detection module 104. Music detection module 104, as well as echo canceller 102 and hybrid 106, may be implemented as part of the user equipment or may be implemented in the network by the operator of the public switched telephone network.

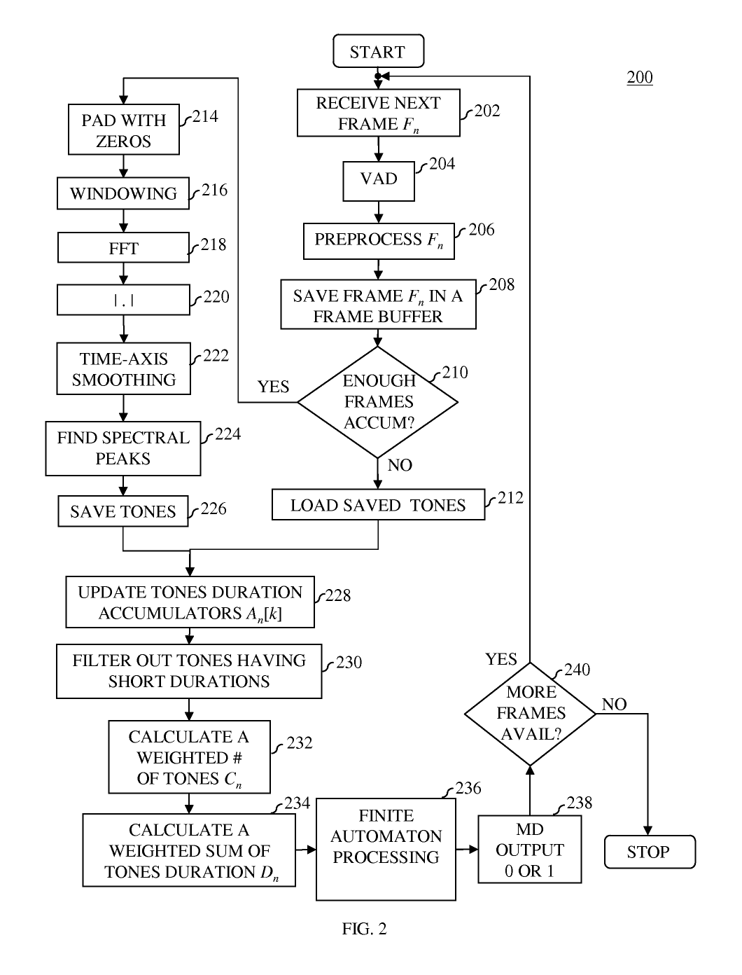

In general, music detection module 104 detects the presence or absence of music in signal Sᵢₙ by using spectral analysis to identify tones in signal Sᵢₙ characteristic of music, opposed to tones characteristic of speech or background noise. Tones that are characteristic of music are represented in the frequency domain by relatively sharp peaks. Typically, music contains a greater number of tones than speech, and those tones are generally longer in duration and more harmonic than tones in speech. Since music typically has more tones than speech and tones that have longer durations, music detection module 104 identifies portions of audio signals having a relatively large number of long-lasting tones as corresponding to music. The operation of music detection module 104 is discussed in further detail below in relation to FIG. 2.

Music detection module 104 preferably receives signal Sᵢₙ in digital format, represented as a time-domain sampled signal having a sampling frequency sufficient to represent telephone quality speech (i.e., a frequency≧8 kHz). Further, signal Sᵢₙ is preferably received on a frame-by-frame basis with a constant frame size and a constant frame rate. Typical packet durations in PSTN are 5 ms, 10 ms, 15 ms, etc., and typical frame sizes for 8 kHz speech packets are 40 samples, 80 samples, 120 samples, etc. Music detection module 104 makes determinations as to whether music is or is not present on a frame-by-frame basis. If music is detected in a frame, then music detection module 104 outputs a value of one to echo canceller 102, instructing echo canceller 102 to not operate the non-linear processing module of echo canceller 102. If music is not detected, then music detection module 104 outputs a value of zero to echo canceller 102, instructing echo canceller 102 to operate the non-linear processing module to cancel echo. Note that, according to alternative embodiments, music detection module 104 may output a value of one when music is not detected and a value of zero when music is detected.

FIG. 2 shows a simplified flow diagram 200 of processing performed by music detection module 104 of FIG. 1 according to one embodiment of the present invention. In step 202, music detection module 104 receives a data frame Fₙ of signal Sᵢₙ, where the frame index n=1, 2, 3, etc. Steps 204 to 222 prepare received data frames Fₙ for spectral analysis, which is performed in step 224 to identify relatively sharp peaks corresponding to candidate musical tones. In step 204, voice activity detection (VAD) is applied to received data frame Fₙ when computational resources are available (as discussed below in relation to the computational resources of the FFT processing in step 218). Voice activity detection distinguishes between non-pauses (i.e., voice and/or music) and pauses in signal Sᵢₙ, and may be implemented using any suitable voice activity detection algorithm, such as the algorithm in International Telecommunication Union (ITU) standard G.711 Appendix II, “A Comfort Noise Payload Definition for ITU-T G.711 Use in Packet-Based Multimedia Communications Systems,” the teachings of which are incorporated herein by reference in their entirety. Voice activity detection may also be implemented using the energy threshold updating and sound detection steps found in FIG. 300 of Russian patent application no. TBD filed as attorney docket no. L09-0721RU1.

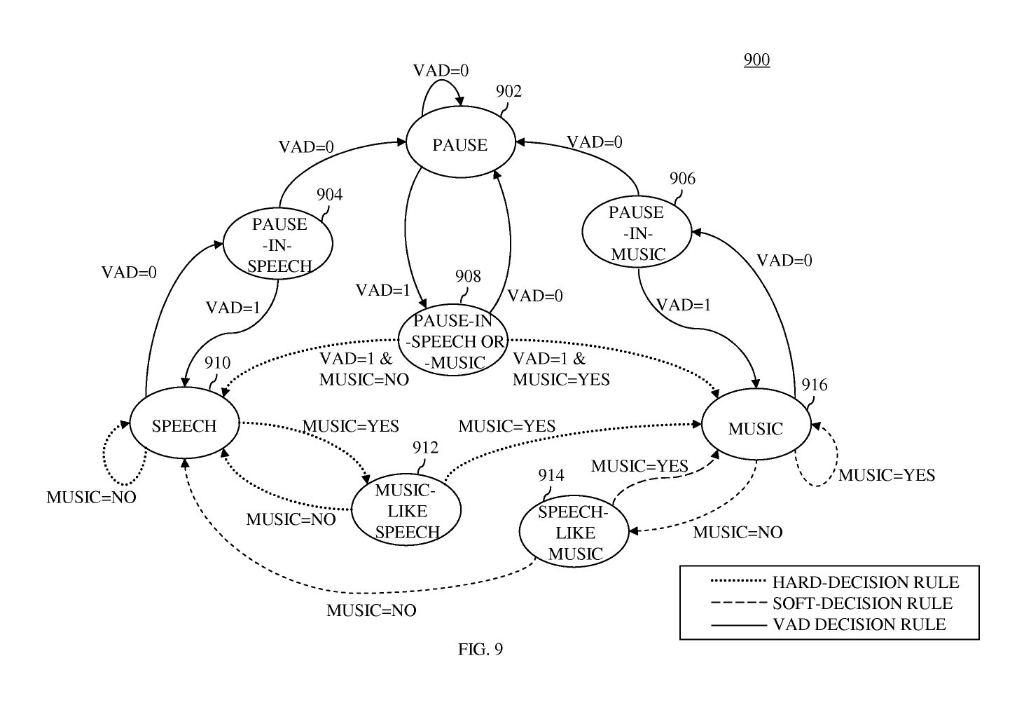

When speech and/or music is detected, voice activity detection generates an output value of one, and, when neither speech nor music is detected, voice activity detection generates an output value of zero. The output value is employed by the finite automaton processing of step 236 as discussed in relation to FIG. 9 below. Note that, in other embodiments, a value of zero may be output when speech or music is detected and a value of one may be output when neither music nor speech is detected.

When computational resources are available (as discussed below in relation to the FFT processing in step 218), received data frame Fₙ is also preprocessed (step 206) to increase the quality of music detection. Preprocessing may include, for example, high-pass filtering to remove the DC component of signal Sᵢₙ and/or a pre-emphasis technique that emphasizes spectrum peaks so that the peaks are easier the detect.

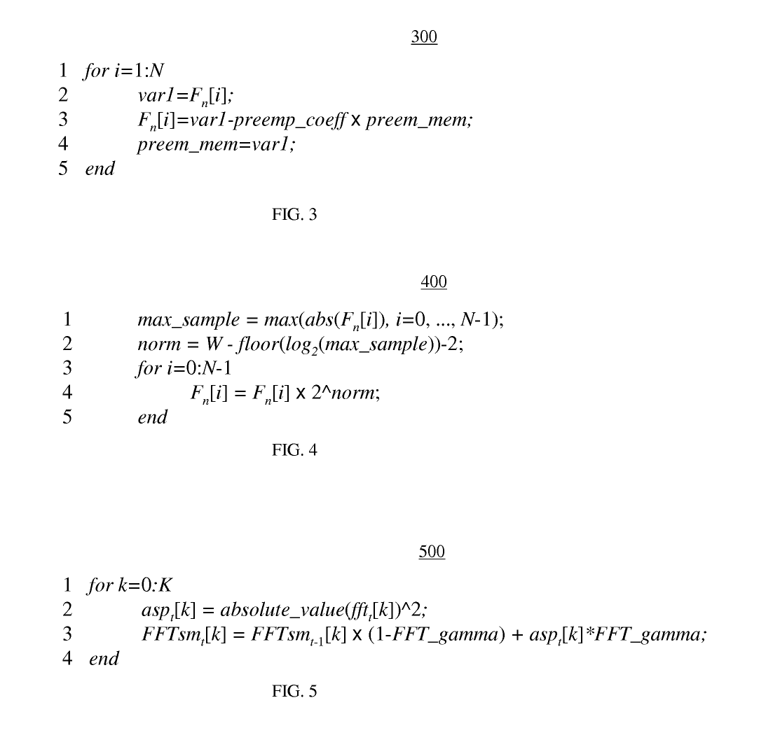

FIG. 3 shows pseudocode 300 according to one embodiment of the present invention that implements a pre-emphasis technique that may be used by the preprocessing of step 206. In code 300, N is the length of the signal window in samples, Fₙ[i] denotes the i^{th} sample of the n^{th} received data frame Fₙ, preemp_coeff is a pre-emphasis coefficient (e.g., 0.95) that is determined empirically, var1 is a first temporary variable, and preem_mem is a second temporary variable that may be initialized to zero. As indicated by line 1, code 300 is performed for each sample i, where i=1, 2, . . . , N. In line 2, temporary variable var1 is set equal to the received data frame sample value Fₙ[i] for the current sample i. In line 3, the received data frame sample value Fₙ[i] is updated for the current sample i by (i) multiplying pre-emphasis coefficient preemp_coeff by the temporary variable preem_mem and (ii) subtracting the resulting product from temporary variable var1. In line 4, the temporary variable preem_mem is set equal to temporary variable var1, which is used for processing the next sample (i+1) of received data frame Fₙ.

Returning to FIG. 2, the possibly preprocessed received data frame Fₙ is saved in a frame buffer (step 208). The frame buffer accumulates one or more received data frames that will be applied to the fast Fourier transform (FFT) processing of step 218. Each FFT frame comprises one or more received data frames. Typically, the number of input values processed by FFT processing (i.e., the FFT frame size) is a power of two. Thus, if the frame buffer accumulates only one received data frame having 120 samples, then an FFT frame size of 2⁷=128 (i.e., an FFT processor having 128 inputs) may be employed. In order to synchronize the 120 samples in the received data frame with the 128 inputs of the FFT processing, the 120 samples the frame are padded (step 214) with 128-120=8 padding samples, each having a value of zero. The eight padding samples may be appended to, for example, the beginning or end of the 120 accumulated samples.

In order to reduce the overall computational complexity of music detection module 104, it is preferred that an FFT frame comprise more than one received data frame Fₙ. For example, for a received data frame size equal to 40 samples, three consecutive received data frames may be accumulated to generate 120 accumulated samples, which are then padded (step 214) with eight samples, each having a value of zero, to generate an FFT frame having 128 samples. To ensure that three frames have been saved in the frame buffer (step 208), a determination is made in step 210 as to whether or not enough frames (e.g., 3) have been accumulated. For this discussion, assume that each FFT frame comprises three received data frames Fₙ. If enough frames have not been accumulated, then old tones are loaded (step 212) as discussed further below. Following step 212, processing continues to step 228, which is discussed below.

If enough frames have been accumulated (step 210), then a sufficient number of padding samples are appended to the accumulated frames (step 214). After the padding values have been appended to generate an FFT frame (e.g., 128 samples), a weighted windowing function (step 216) is applied to avoid spectral leakage that can result from performing FFT processing (step 218). Spectral leakage is an effect well known in the art where, in the spectral analysis of the signal, some energy appears to have “leaked” out of the original signal spectrum into other frequencies. To counter this effect, a suitable windowing function may be used, including a Hamming window function or other windowing function known in the art that mitigates the effects of spectral leakage, thereby increasing the quality of tone detection. According to alternative embodiments of the present invention, the windowing function of step 216 may be excluded to reduce computational resources or for other reasons.

The windowed FFT frame is applied to the FFT processing of step 218 to generate a frequency-domain signal, comprising 2K complex Fourier coefficients fftₜ[k], where the FFT frame index t=0, 1, 2, etc. The 2K complex Fourier coefficients fftₜ[k] correspond to an FFT spectrum, and each complex Fourier coefficient fftₜ[k] corresponds to a different frequency k in the spectrum, where k=0, . . . , 2K−1. Note that, if the FFT processing of step 218 is implemented using fixed-point arithmetic, then frame normalization (not shown) may be needed before performing the FFT processing in order to improve the numeric quality of fixed-point calculations.

FIG. 4 shows pseudocode 400 according to one embodiment of the present invention that may be used to implement FFT frame normalization. In line 1, the magnitude max_sample of the sample having the largest magnitude is determined by taking the absolute value (i.e., abs) of each of the samples Fₙ[i] in the frame, where i=0, . . . , N−1, and finding the maximum (i.e., max) of the resulting absolute values. In line 2, a normalization variable norm that is used to normalize each sample Fₙ[i] in the frame is calculated, where the floor function (i.e., floor) rounds to the largest previous integer value and W represents the integer number of digits used to represent each fixed-point value. Finally, as shown in lines 3 and 4, each received data frame sample Fₙ[i], where i=0, . . . , N−1, is normalized by (i) raising a value of two to an exponent equal to normalization variable norm and (ii) multiplying each received data frame sample Fₙ[i] by the result.

Referring back to FIG. 2, the absolute value (step 220) is taken of each of the first K+1 complex Fourier coefficients fftₜ[k] for the t^{th} FFT frame, each of which comprises an amplitude and a phase, to generate a magnitude value absolute_value(fftₜ[k]). The remaining K−1 coefficients fftₜ[k] are not used because they are redundant. The K+1 magnitude values absolute_value(fftₜ[k]) are smoothed with magnitude values absolute_value(fftₜ₋₁[k]) from the previous (t−1)^{th} FFT frame using a time-axis smoothing technique (step 222). The time-axis smoothing technique emphasizes the stationary harmonic tones and performs spectrum denoising. Time-axis smoothing may be performed using any suitable smoothing technique including, but not limited to, rectangular smoothing, triangular smoothing, and exponential smoothing. According to alternative embodiments of the present invention, time-axis smoothing 222 may be omitted to reduce computational resources or for other reasons. Employing time-axis smoothing 222 increases the quality of music detection but also increases the computational complexity of music detection.

FIG. 5 shows pseudocode 500 according to one embodiment of the present invention that implements exponential smoothing. In code 500, t is the index of the current FFT frame, (t−1) is the index of the previous FFT frame, fftₜ[k] is the complex Fourier coefficient corresponding to the k^{th} frequency, aspₜ[k] is a coefficient of the power spectrum corresponding to the k^{th} frequency of the t^{th} FFT frame, FFTsmₜ[k] is the smoothed power spectrum coefficient corresponding to the k^{th} frequency of the t^{th} FFT frame, FFTsmₜ₋₁[k] is the smoothed power spectrum coefficient corresponding to the k^{th} frequency of the (t−1)^{th} FFT frame, and FFT_gamma is a smoothing coefficient determined empirically, where 0<FFT_gamma≦1.

As shown in line 1, code 500 is performed for each frequency k, where k=0, . . . , K. In line 2, the k^{th} power spectrum coefficient aspₜ[k] for the current FFT frame t is generated by squaring the magnitude value absolute_value(fftₜ[k]) of the k^{th} complex Fourier coefficient fftₜ[k]. In line 3, the smoothed power spectrum FFT coefficient FFTsmₜ[k] for the current frame t is generated based on the smoothed power spectrum FFT coefficient FFTsmₜ₋₁[k] for the previous frame (t−1), the smoothing coefficient FFT_gamma, and the power spectrum coefficient aspₜ[k] for the current frame t. The result of applying code 500 to a plurality of FFT frames t is a smoothed power spectrum.

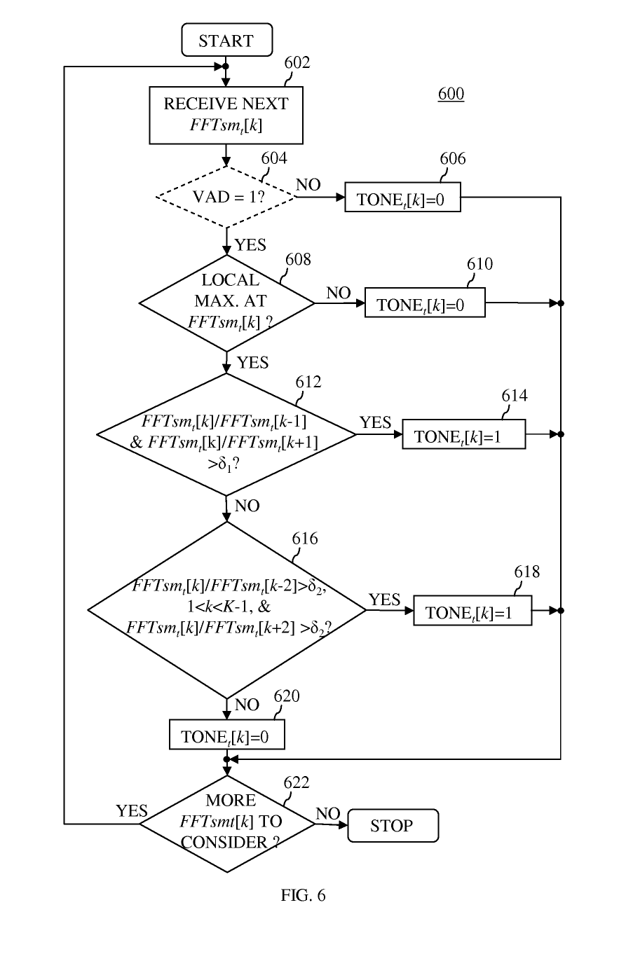

Returning to FIG. 2, to find candidate positions of musical tones, music detection module 104 searches for relatively sharp spectral peaks (step 224) in the smoothed power spectrum. The spectral peaks are identified by locating the local maxima across the smoothed power spectrum FFTsmₜ[k] of each FFT frame t, and determining whether the smoothed power spectrum coefficients FFTsmₜ[k] corresponding to identified local maxima are sufficiently large relative to adjacent smoothed power spectrum coefficients FFTsmₜ[k] corresponding to the same frame t (i.e., the local maxima are relatively large maxima). To further understand the processing performed by the spectral-peak finding of step 224, consider FIG. 6.

FIG. 6 shows a simplified flow diagram 600 according to one embodiment of the present invention of processing that may be performed by music detection module 104 of FIG. 1 to find candidate musical tones. Upon startup, a smoothed power spectrum coefficient FFTsmₜ[k] corresponding to the t^{th} FFT frame and the k^{th} frequency is received (step 602). A determination may be made in step 604 as to whether the value output by the voice activity detection of step 204 of FIG. 2 corresponding to the current frequency k is equal to one. If the value output by the voice activity detection is not equal to one, indicating that neither speech nor music is present, then variable TONEₜ[k] is set to zero (step 606) and processing proceeds to step 622, which is described further below. Setting variable TONEₜ[k] to zero indicates that the smoothed power spectrum coefficient FFTsmₜ[k] for FFT frame t does not correspond to a candidate musical tone. Note that, if the voice activity detection is not implemented, then the decision of step 604 is skipped and processing proceeds to the determination of step 608. Further, if the voice activity detection is implemented, but is not being used in order to reduce computational resources, then, as described above, the output of the voice activity detection may be fixed to a value of one.

If the value output by the voice activity detection of step 204 is equal to one, indicating that music and/or speech is present, then the determination of step 608 is made as to whether or not there is a local maximum at frequency k. This determination may be performed by comparing the value of smoothed power spectrum coefficient FFTsmₜ[k] corresponding to frequency k to the values of smoothed power spectrum coefficients FFTsmₜ[k−1] and FFTsmₜ[k+1] corresponding to frequencies k−1 and k+1. If the value of smoothed power spectrum coefficient FFTsmₜ[k] is not larger than the values of both smoothed power spectrum coefficients FFTsmₜ[k−1] and FFTsmₜ[k+1], then the smoothed power spectrum coefficient FFTsmₜ[k] does not correspond to a candidate musical tone. In this case, variable TONEₜ[k] is set to zero (step 610) and processing proceeds to step 622, which is described further below.

If, on the other hand, the value of the smoothed power spectrum coefficient FFTsmₜ[k] is larger than the values of both smoothed power spectrum coefficients FFTsmₜ[k−1] and FFTsmₜ[k+1], then a local maximum corresponds to frequency k. In this case, up to two sets of threshold conditions are considered (steps 612 and 616) to determine whether the identified local maximum is a sufficiently sharp peak. If either of these sets of conditions is satisfied, then variable TONEₜ[k] is set to one. Setting variable TONEₜ[k] indicates that the smoothed power spectrum coefficient FFTsmₜ[k] corresponds to a candidate musical tone.

The first set of conditions of step 612 comprises two conditions. First, smoothed power spectrum coefficient FFTsmₜ[k] is divided by smoothed power spectrum coefficient FFTsmₜ[k−1] and the resulting value is compared to a constant δ₁. Second, smoothed power spectrum coefficient FFTsmₜ[k] is divided by smoothed power spectrum coefficient FFTsmₜ[k+1] and the resulting value is compared to constant δ₁. Constant δ₁ may be selected empirically and may depend on variables such as FFT frame size, the type of spectral smoothing used, the windowing function used, etc. In one implementation, constant δ₁ was set equal to 3 dB (i.e., ˜1.4 in linear scale). If both resulting values are greater than constant δ₁, then the first set of conditions of step 612 is satisfied, and variable TONEₜ[k] is set to one (step 614). Processing then proceeds to step 622 discussed below. Note that the first set of conditions of step 612 may be implemented using fixed-point arithmetic without using division, since FFTsmₜ[k]/FFTsmₜ[k−1]>δ₁ is equivalent to FFTsmₜ[k]−δ₁×FFTsmₜ[k−1]>0 and FFTsmₜ[k]/FFTsmₜ[k+1]>δ₁ is equivalent to FFTsmₜ[k]−δ₁×FFTsmₜ[k+1]>0.

If either resulting value is not greater than constant δ₁, then the first set of conditions of step 612 is not satisfied, and a determination is made (step 616) as to whether a second set of conditions is satisfied. The second set of conditions comprises three conditions. First, smoothed power spectrum coefficient FFTsmₜ[k] is divided by smoothed power spectrum coefficient FFTsmₜ[k−2] and the resulting value is compared to a constant δ₂. Second, it is determined whether the current frequency index k has a value greater than one and less than K−1. Third, smoothed power spectrum coefficient FFTsmₜ[k] is divided by smoothed power spectrum coefficient FFTsmₜ[k+2] and the resulting value is compared to constant δ₂. Similar to constant δ₁, constant δ₂ may be selected empirically and may depend on variables such as FFT frame size, the type of spectral smoothing used, the windowing function used, etc. In one implementation, constant δ₂ was set equal to 12 dB (i.e., ˜4 in linear scale). If both resulting values are greater than constant δ₂ and 1≦k≦K−1, then the second set of conditions of step 616 is satisfied and variable TONEₜ[k] is set to one (step 618). Processing then proceeds to step 622 discussed below. Note that FFTsmₜ[k]/FFTsmₜ[k−2]>δ₂ may be implemented using fixed-point arithmetic without using divisions because this comparison is equivalent to FFTsmₜ[k]−δ₂×FFTsmₜ[k−2]>0. Similarly, FFTsmₜ[k]/FFTsmₜ[k+2]>δ₂ may be implemented as FFTsmₜ[k]−δ₂×FFTsmₜ[k+2]>0.

If any one of the conditions in the second set of conditions of step 616 is not satisfied, then variable TONEₜ[k] is set to zero (step 620). The determination of step 622 is made as to whether or not there are any more smoothed power spectrum coefficients FFTsmₜ[k] for the current FFT frame t to consider. If there are more smoothed power spectrum coefficients FFTsmₜ[k] to consider, then processing returns to step 602 to receive the next smoothed power spectrum coefficient FFTsmₜ[k]. If there are no more smoothed power spectrum coefficients FFTsmₜ[k] to consider for the current FFT frame t, then processing is stopped.

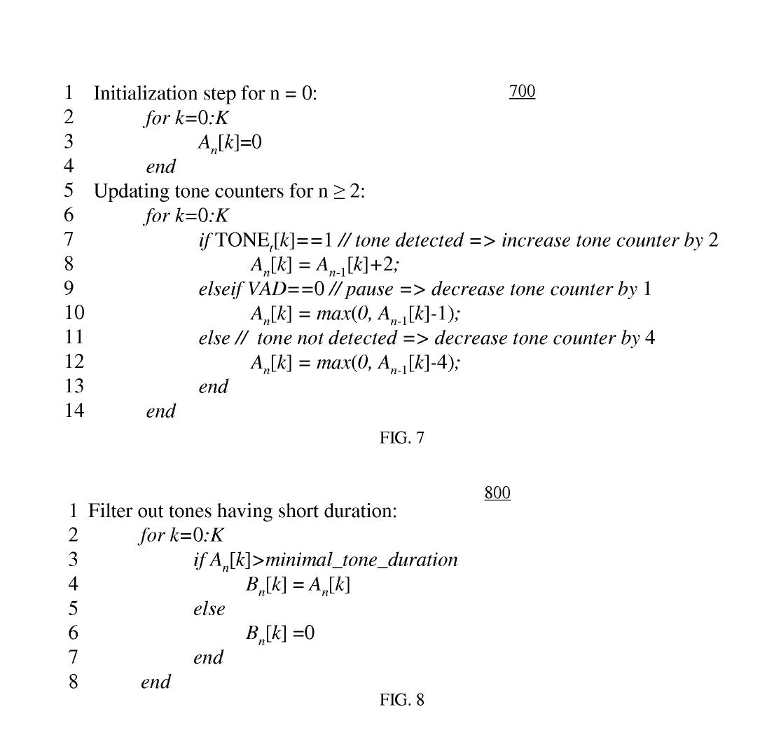

Returning to FIG. 2, the set of variables TONEₜ[k] are saved (step 226). A set of tone accumulators Aₙ[k] is then updated (step 228) based on variables TONEₜ[k], as described below in relation to FIG. 7. Each tone accumulator Aₙ[k] corresponds to a duration of a candidate musical tone for the k^{th} frequency. After the set of tone accumulators Aₙ[k] has been updated, the tone accumulators Aₙ[k] are compared to a threshold value to filter out the candidate musical tones that are short in duration (step 230), as described below in relation to FIG. 8. The remaining candidate musical tones that are not filtered out are presumed to correspond to music.

Note that steps 214 to 226 are performed only once for each FFT frame t (e.g., upon receiving every third data frame Fₙ. When the first and second data frames F₁ and F₂ are received, steps 214 to 226 are not performed. Rather, variables TONEₜ[k] for k=0, . . . , K are initialized to zero, and steps 228 to 238 are performed based on the initialized values. For all other data frames n that are received when variables TONEₜ[k] are not generated, the previously stored set of variables TONEₜ[k] are loaded (step 212) and used to update tone accumulators Aₙ[k] (step 228).

Since the first FFT frame t=1 does not exist until after the third data frame F₃ is received, an initial set of variables TONE₀[k] is set to zero. Upon receiving each of the first and second data frames F₁ and F₂, the initial set of variables TONE₀[k] is loaded (step 212) and used to update the sets of tone accumulators A₁[k] and A₂[k] for the first two data frames (step 228). Upon receiving the third data frame F₃, the set of variables TONE₁[k] for the first FFT frame is generated and saved (steps 214-226). This first set of variables TONE₁[k] is used to update the set of tone accumulators A₃[k] corresponding to the third received data frame F₃ (step 228). Since the second FFT frame t=2 does not exist until after the sixth data frame F₆ is received, for the fourth and fifth received data frames F₄ and F₅, the first set of variables TONE₁[k] is loaded (step 212) to update (step 228) the sets of tone accumulators A₄[k] and A₅[k] corresponding to the fourth and fifth received data frames F₄ and F₅. Upon receiving the sixth data frame F6, the set of variables TONE₂[k] is generated for the second FFT frame. This second set of variables TONE₂[k] is used to update (step 228) the sets of tone accumulators A₆[k], A₇[k], and A₈[k] for the sixth, seventh, and eighth received data frames F₆, F₇, and F₈.

Typically, the FFT processing of step 218 uses a relatively large amount of computational resources. To reduce computational resources when FFT processing is performed (e.g., upon receiving every third data frame Fₙ), the voice activity detection of step 204 and the frame preprocessing of step 206 are skipped. In such instances, the finite automaton processing of step 236 uses a fixed value of one in lieu of the output from the voice activity detection of step 204. When FFT processing is not performed (e.g., after receiving the first, second, fourth, fifth, seventh, eighth, and so on data frames), the voice activity detection of step 204 and the frame preprocessing of step 206 are performed.

According to alternative embodiments of the present invention, one of the voice activity detection of step 204 and the frame preprocessing of step 206 may be skipped when the FFT processing of step 218 is performed, rather than skipping both the voice activity detection and the frame preprocessing. According to further embodiments of the present invention, the voice activity detection and the frame preprocessing are performed at all times, even when the FFT processing is performed. According to yet further embodiments of the present invention, the voice activity detection and/or the frame preprocessing may be omitted from the processing performed in flow diagram 200 altogether. Simulations have shown that music detection works relatively well when voice activity detection and frame preprocessing are not employed; however, the quality of music detection increases (i.e., error rate and detection delay decrease) when voice activity detection and frame preprocessing are employed.

FIG. 7 shows pseudocode 700 according to one embodiment of the present invention that may be used to update the set of tone accumulators Aₙ[k] in step 228 of FIG. 2. As shown in lines 1 to 4, initial tone accumulators Aₙ₌₀[k] corresponding to tones 0 to K are set to a value of zero. For each received data frame n≧2, each tone accumulator Aₙ[k], where k=0, . . . , K, is updated as shown in lines 5 to 14. In particular, as shown in lines 7 and 8, if TONEₜ[k] is equal to one, then corresponding tone accumulator Aₙ[k] is updated by increasing the previous tone accumulator value Aₙ₋₁[k]. In this implementation, a weighting value of two is applied to the previous tone accumulator value Aₙ₋₁[k]. If TONEₜ[k] is not equal to one, and the output of the voice activity detection of step 204 of FIG. 2 is equal to zero, then tone accumulator Aₙ[k] is set to the maximum of (i) zero and (ii) the previous tone accumulator value Aₙ₋₁[k] decreased by a weighting value of one, as shown in lines 9 and 10. If TONEₜ[k] is not equal to one, and the output of the voice activity detection of step 204 of FIG. 2 is not equal to zero, then tone accumulator Aₙ[k] is set to the maximum of (i) zero and (ii) the previous tone accumulator value Aₙ₋₁[k] decreased by a weighting value of four, as shown in lines 11 and 12. Note that the weighting values of positive two, negative one, and negative four in lines 8, 10, and 12, respectively, are exemplary, and that other weighting values may be used. For example, a previous tone accumulator value Aₙ₋₁[k] may be increased by one if TONEₜ[k] is equal to one and decreased by one any time that TONEₜ[k] is not equal to one.

FIG. 8 shows pseudocode 800 according to one embodiment of the present invention that may be used to filter out candidate musical tones that are short in duration in step 230 of FIG. 2. As shown in line 2, filtering is performed for each tone accumulator Aₙ[k] of the n^{th} frame, where k=0, . . . , K. Each tone accumulator Aₙ[k] is compared to a constant minimal_tone_duration that has a value greater than zero (e.g., 10). The value of constant minimal_tone_duration may be determined empirically and may vary based on the frame size, the frame rate, the sampling frequency, and other variables. If tone accumulator Aₙ[k] is greater than constant minimal_tone_duration, then filtered tone accumulator Bₙ[k] is set equal to tone accumulator Aₙ[k]. If tone accumulator Aₙ[k] is not greater than constant minimal_tone_duration, then filtered tone accumulator Bₙ[k] is set equal to zero.

Returning to FIG. 2, after filtering out candidate musical tones that are short in duration, a weighted number Cₙ of candidate musical tones and a weighted sum Dₙ of candidate musical tone durations are calculated (steps 232 and 234) for the received data frame n as shown in Equations (1) and (2), respectively:

Cₙ=sum(Wgt[k]×sign(Bₙ[k]),k=0, . . . ,K) (1)

Dₙ=sum(Wgt[k]×Bₙ[k],k=0, . . . ,K) (2)

where “sign” denotes the signum function that returns a value of positive one if the argument is positive, a value of negative one if the argument is negative, and a value of zero if the argument is equal to zero. Note that pseudocode 700 of FIG. 7 updates tone accumulators Aₙ[k] such that tone accumulators Aₙ[k] never have a value less than zero (see, e.g., lines 7 to 12). As a result, the filtered tone accumulators Bₙ[k] should never have a value less than zero, and sign(Bₙ[k]) should never return a value of negative one. Wgt[k] are weight values of a weighting vector, −1≦Wgt[k]≦1, that can be selected empirically by maximizing music detection reliability for different candidate weighting vectors. Since music tends to have louder high-frequency tones than speech, music detection performance significantly increases when weights Wgt[k] corresponding to frequencies lower than 1 kHz are smaller than weights Wgt[k] corresponding to frequencies higher than 1 kHz. Note that the weighting of Equations (1) and (2) can be disabled by setting all of the weight values Wgt[k] to one.

Once the weighted number Cₙ of candidate musical tones and the weighted sum Dₙ of candidate musical tone durations are determined, the results are applied to the finite automaton processing of step 236 along with the decision from the voice activity detection of step 204 (i.e., 0 for noise and 1 for speech and/or music). Finite automaton processing, described in further detail in relation to FIG. 9, implements a final decision smoothing technique to decrease the number of errors in which speech is falsely detected as music, and thereby enhance music detection quality. If the finite automaton processing detects music, then the finite automaton processing outputs (step 238) a value of one to, for example, echo canceller 102 of FIG. 1. If music is not detected, then the finite automaton processing outputs (step 238) a value of zero. The decision of step 240 is then made to determine whether or not more received data frames are available for processing. If more frames are available, then processing returns to step 202. If no more frames are available, then processing stops.

FIG. 9 shows a simplified diagram of state machine 900 according to one embodiment of the present invention for the finite automaton processing of step 236 of FIG. 2. As shown, state machine 900 has three main states: pause state 902, speech state 910, and music state 916, and five other (i.e., intermediate) states that correspond to transitions between the three main states: pause-in-speech state 904, pause-in-music state 906, pause-in-speech or -music state 908, music-like speech state 912, speech-like music state 914, and. In general, a value of 1 is output by the finite automaton processing when state machine 900 is in any one of the music state 916, pause-in-music state 906, speech-like music state 914, and pause-in-speech or -music state 908. For all other states, finite automaton processing 236 outputs a value of zero.

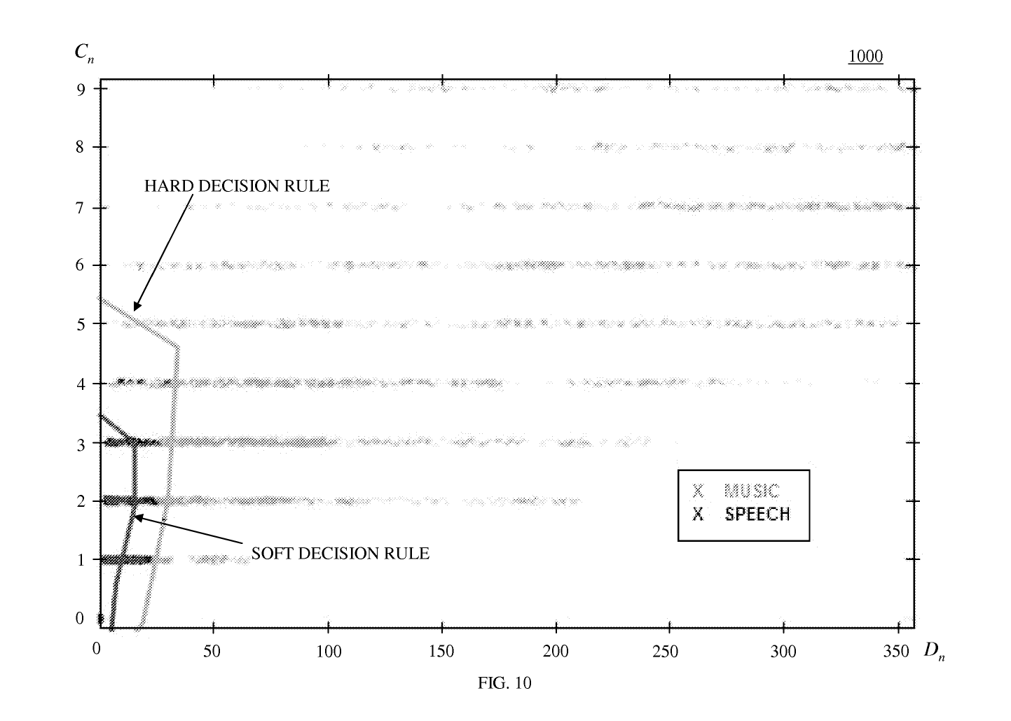

Transitions between these states are performed based on three rules: a soft-decision rule, a hard-decision rule, and a voice activity detection rule. The voice activity detection rule is merely the output of the voice activity detection of step 204 of FIG. 2. In general, if the output of the voice activity detection has a value of zero, indicating that a pause is detected, then state machine 900 transitions in the direction of pause state 902. If, on the other hand, the output of the voice activity detection has a value of one, indicating that a pause is not detected, then state machine 900 transitions in the direction of music state 916 or speech state 910. The soft-decision and hard-decision rules may be determined by (i) generating values of Cₙ and Dₙ for a set of training data that comprises random music, noise, and speech samples and (ii) plotting the values of Cₙ and Dₙ on a graph as shown in FIG. 10.

FIG. 10 shows an exemplary graph 1000 used to generate the soft-decision and hard-decision rules used in state machine 900 of FIG. 9. The weighted sum Dₙ values are plotted on the x-axis and the weighted number Cₙ values are plotted on the y-axis. Each black “x” corresponds to a received data frame n comprising only speech and each gray “x” corresponds to a received data frame n comprising only music. Two lines are drawn through the graph: a gray line, identified as the hard-decision rule, and a black line, identified as the soft-decision rule. The hard-decision rule is drawn at the boundary between (i) an area on the graph that corresponds to only music frames and (ii) an area on the graph that corresponds to both speech and music frames. The soft-decision rule is drawn at the boundary between (i) an area on the graph that corresponds to only speech frames and (ii) an area on the graph that corresponds to both speech and music frames. In other words, the area to the right of the hard-decision rule has frames comprising only music, the area between the hard-decision rule and the soft-decision rule have both speech frames and music frames, and the area to the left of the soft-decision rule has frames comprising only speech.

From graph 1000, the hard-decision rule may be derived by determining the pairs of Cₙ and Dₙ values (i.e., points in the Cartesian plane having coordinate axes of Cₙ and Dₙ depicted in FIG. 10) that the gray line (i.e., the hard-decision rule line) intersects. In this graph, the hard-decision rule is satisfied, indicating that a frame corresponds to music only, when (Cₙ=5 and Dₙ>20) or (Cₙ=4 and Dₙ>30) or (Cₙ=3 and Dₙ>25) or (Cₙ=2 and Dₙ>20) or (Cₙ=1 and Dₙ>15). The soft-decision rule is satisfied, indicating that a frame corresponds to speech or music, when (Cₙ>3) or (Cₙ=3 and Dₙ>10) or (Cₙ=2 and Dₙ>10) or (Cₙ=1 and Dₙ>8). If the Cₙ and Dₙ values for a frame n do not satisfy either of these rules, then the frame n is presumed to not contain music.

Referring back to FIG. 9, suppose that state machine 900 is in pause state 902. If the voice activity detection of step 204 of FIG. 2 outputs a value of zero, indicating that the current frame does not contain speech or music, then state machine 900 remains in pause state 902 as indicated by the arrow looping back into pause state 902. If, on the other hand, the voice activity detection outputs a value of one, indicating that the current frame contains speech or music, then state machine 900 transitions from pause state 902 to pause-in-speech or -music state 908.

When state machine 900 is in pause-in-speech or -music state 908, state machine 900 will transition to (i) pause state 902 if the output of the voice activity detection switches back to a value of zero for the next received data frame, (ii) speech state 910 if the output of the voice activity detection remains equal to one for the next received data frame and the hard-decision rule is not satisfied (i.e., music is not detected in the next received data frame), or (iii) music state 916 if the output of the voice activity detection remains equal to one for the next received data frame and the hard-decision rule is satisfied (i.e., music is detected in the next received data frame).

When state machine 900 is in pause-in-speech state 904, state machine 900 will transition to (i) pause state 902 if the output of the voice activity detection is equal to zero or (ii) speech state 910 if the output of the voice activity detection is equal to one.

When state machine 900 is in speech state 910, state machine 900 will transition to (i) pause-in-speech state 904 if the voice activity detection outputs a value of zero or (ii) music-like speech state 912 if the hard-decision rule is satisfied (i.e., music is detected). State machine 900 will remain in speech state 910, as indicated by the arrow looping back into speech state 910, if the hard-decision rule is not satisfied (i.e., music is not detected).

When state machine 900 is in music-like speech state 912, state machine 900 will transition to (i) speech state 910 if the hard-decision rule is not satisfied (i.e., music is not detected) or (ii) music state 916 if the hard-decision rule is satisfied (i.e., music is detected).

When state machine 900 is in speech-like music state 914, state machine 900 will transition to (i) speech state 910 if the soft-decision rule is not satisfied, indicating that music is not present or (ii) music state 916 if the soft-decision rule is satisfied, indicating that music may be present.

When state machine 900 is in music state 916, state machine 900 will transition to (i) speech-like music state 914 if the soft-decision rule is not satisfied, indicating that music is not present or (ii) pause-in-music state 906 if the output of the voice activity detection has a value of zero. State machine 900 will remain in music state 916, as indicated by the arrow looping back into music state 916, if the soft-decision rule is satisfied, indicating that music may be present.

When state machine 900 is in pause-in-music state 906, state machine 900 will transition to (i) pause state 902 if the output of the voice activity detection has a value of zero or (ii) music state 916, if the output of the voice activity detection has a value of one.

In some embodiments of the present invention, a transition from one state to another in state machine 900 occurs immediately after one of the rules is satisfied. For example, a transition from pause state 902 to pause-in-speech or -music state 908 occurs immediately after the output of the voice activity detection switches from a value of zero to a value of one.

According to alternative embodiments, in order to smooth the outputs of state machine 900, a transition from one state to another occurs only after one of the rules is satisfied for a specified number (>1) of consecutive frames. These embodiments may be implemented in many different ways using a plurality of hangover counters. For example, according to one embodiment, three hangover counters may be used, where each hangover counter corresponds to a different one of the three rules. As another example, each state may have its own set of one or more hangover counters.

The hangover counters may be implemented in many different ways. For example, a hangover counter may be incremented each time one of the rules is satisfied, and reset each time one of the rules is not satisfied. As another example, a hangover counter may be (i) incremented each time a relevant rule that is satisfied for the current frame is the same as in the previous data frame and (ii) reset to zero each time the relevant rule that is satisfied changes from the previous data frame. If the hangover counter becomes larger than a specified hangover threshold, then state machine 900 transitions from the current state to the next state. The hangover threshold may be determined empirically.

As an example of the operation of a hangover counter according to one embodiment, suppose that state machine 900 is in pause state 902, and the output of the voice activity detection switches from a value of zero, indicating that neither speech nor music is present in the previous data frame, to a value of one, indicating that speech or music is present in the current data frame. State machine 900 does not switch states immediately. Rather, a hangover counter is increased each time that the output of the voice activity detection remains equal to one. When the hangover counter exceeds the hangover threshold, state machine 900 transitions from pause state 902 to pause-in-speech or -music state 908. If the voice activity detection switches to zero before the hangover counter exceeds the hangover threshold, then the hangover counter is reset to zero.

According to further alternative embodiments, transitions from some states may be instantaneous and transitions between other states may be performed using hangover counters. For example, transitions from the intermediate states (i.e., pause-in-speech state 904, pause-in-speech or -music state 908, music-like speech state 912, speech-like music state 914, and pause-in-music state 906) may be performed using hangover counters, while transitions from pause state 902, speech state 910, and music state 916 may instantaneous. Each different state can have its own unique hangover counter and hangover threshold value. Further, instantaneous transitions can be achieved by specifying a value of zero for the relevant hangover threshold.

Compared to stochastic model-based techniques, the present invention is less complex, allowing the present invention to be implemented in real-time low-latency processing. Compared to deterministic model-based techniques, the present invention has lower detection error rates. Thus, the present invention is a compromise between low computational complexity and high detection quality. Unlike other methods that use encoded speech features, and are thus limited to being used with a specific coder-decoder (CODEC), the present invention is more universal because it does not require any additional information other than the input signal.

The complexity of the processing performed in flow diagram 200 of FIG. 2 may be estimated in terms of integer multiplications per second. The frame preprocessing of step 206 performs approximately N multiplications. The number N_{VAD} of multiplications performed by the voice activity detection of step 204 varies depending on the voice activity detection method used. The windowing of step 216 performs approximately 2K+1 multiplications. The FFT processing of step 218 performs approximately 2K log₂ K integer multiplications, and approximately an additional 2K multiplications are performed if frame normalization is implemented before the FFT processing. The power spectrum calculation (i.e., line 2 of pseudocode 500 of FIG. 5) and the time-axis smoothing of step 222, each perform approximately 2(K+1) multiplications. The spectral-peak finding of step 224 performs a maximum of approximately K/2×2×2=2K multiplications. Calculations (steps 232 and 234) of Cₙ and Dₙ perform approximately 2K total multiplications.

According to embodiments of the present invention in which frame preprocessing, voice activity detection, windowing, frame normalization, and time-axis smoothing are performed at all times, the total number of integer multiplications performed for music detection is approximately N+N_{VAD}+(2K+1)+2K log₂ K+2K+2(K+1)+2(K+1)+2K+2K=N+N_{VAD}+12K+5+2K log₂ K multiplications. Typical voice activity detection uses approximately 4×N multiplications per frame if exponential smoothing of the samples' energy is used. For a typical value of K=64 (i.e., 5 ms frame for 8 kHz signal) and N=40, the peak complexity is equal to about 0.35 million multiplications per second.

According to embodiments of the present invention in which frame preprocessing, voice activity detection, windowing, and time-axis smoothing are not performed, the total number of integer multiplications performed for music detection is approximately 2K log₂ K+2K+2(K+1)+2(K+1)+2K+2K. For K=64, the peak complexity is equal to approximately 0.28 million multiplications per second. Note that these estimates do not account for the number of summations and subtractions, as well as processing time needed for memory read and write operations.

Although the present invention was described as accumulating three received data frames Fₙ to generate an FFT frame for FFT processing, the present invention is not so limited. The present invention may be implemented such that (i) fewer than three received data frames Fₙ are accumulated to generate an FFT frame, including as few as one received data frame Fₙ, or (ii) greater than three received data frames Fₙ are accumulated to generate an FFT frame. In embodiments in which an FFT frame comprises only one received data frame Fₙ, steps 210, 212, and 226 may be omitted, such that processing flows from step 208 directly to step 214 and steps 214 to 224 are performed for each received data frame Fₙ, and the set of variables TONEₜ[k] generated for each received data frame Fₙ is used immediately to update (step 228) tone accumulators Aₙ[k].

Further, although the spectral-peak finding of step 600 of FIG. 6 was described as comparing the smoothed power coefficient FFTsmₜ[k] for the current frequency k to neighboring smoothed power coefficients FFTsmₜ[k−1], FFTsmₜ[k+1], FFTsmₜ[k−2], and FFTsmₜ[k+2], the present invention is not so limited. According to alternative embodiments, spectral peak finding may be performed by comparing the smoothed power coefficient FFTsmₜ[k] to more-distant smoothed power coefficients such as FFTsmₜ[k−3] and FFTsmₜ[k+3] in addition to or instead of the less-distant coefficients of FIG. 6.

Even further, although state machine 900 was described as having eight states, the present invention is not so limited. According to alternative embodiments, state machines of the present invention may have more than or fewer than eight states. For example, according to some embodiments, the state machine could have six states, wherein pause-in-speech state 904 and pause-in-music state 906 are omitted. In such embodiments, speech state 910 and music state 916 would transition directly to pause state 902. In addition, as described above, hangover counters could be used to smooth the transitions to speech state 910 and music state 916.

Even yet further, although music detection modules of the present invention were described relative to their use with public switched telephone networks, the present invention is not so limited. The present invention may be used in suitable applications other than public switched telephone networks.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, general-purpose computer, or other processor.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. The present invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor or other processor, the program code segments combine with the processor to provide a unique device that operates analogously to specific logic circuits.

The present invention can also be embodied in the form of a bitstream or other sequence of signal values stored in a non-transitory recording medium generated using a method and/or an apparatus of the present invention.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. For example, voice activity detection 204 in FIG. 2 may be performed before, concurrently with, or after frame preprocessing 206. As another example, calculating the weighted number of tones Cₙ (step 232) may be performed before, concurrently with, or after calculation of the weighted sum of tone durations Dₙ (step 234). Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A processor-implemented method for processing audio signals to determine whether or not the audio signals correspond to music, the method comprising:
(a) the processor identifying a plurality of tones corresponding to long-duration spectral peaks in a received audio signal (e.g., Sin);
(b) the processor generating a value (e.g., Cn) for a first metric based on number of the identified tones;
(c) the processor generating a value (e.g., Dn) for a second metric based on duration of the identified tones; and
(d) the processor determining whether or not the received audio signal corresponds to music based on the first and second metric values.

2. The processor-implemented method of claim 1, wherein step (a) comprises:
(a1) the processor transforming the received audio signal from a time domain into a frequency domain;
(a2) the processor identifying relatively sharp spectral peaks in the frequency domain;
for each relatively sharp spectral peak,
(a3) the processor generating an accumulator value (e.g., An[k]) based on duration of the relatively sharp spectral peak;
(a4) the processor comparing the accumulator value to an accumulator threshold value; and
(a5) the processor identifying the relatively sharp spectral peak as one of the long-duration spectral peaks in the received audio signal, if the accumulator value is greater than the accumulator threshold value.

3. The processor-implemented method of claim 2, wherein step (c) comprises the processor generating the second metric value as a sum of the accumulator values for the long-duration spectral peaks.

4. The processor-implemented method of claim 3, wherein the processor generates the first and second metric values by assigning different weight values (e.g., Wgt[k]) to different long-duration spectral peaks.

5. The processor-implemented method of claim 4, wherein the processor assigns smaller weight values to lower-frequency long-duration spectral peaks.

6. The processor-implemented method of claim 1, wherein the processor determines whether or not the received audio signal corresponds to music based on hard and soft decision rules that are both functions of the first and second metrics.

7. The processor-implemented method of claim 6, wherein:
the first and second metrics define a two-dimensional metric space;
the hard decision rule delineates a music-only region in the two-dimensional metric space comprising substantially only frames of the received audio signal corresponding to music; and
the soft decision rule delineates a speech-only region in the two-dimensional metric space comprising substantially only frames of the received audio signal corresponding to speech.

8. The processor-implemented method of claim 7, wherein:
the processor implements a state machine comprising a plurality of states; and
the state machine transitions from a first state to a second state based on the processor applying at least one of the hard and soft decision rules to the first and second metric values.

9. The processor-implemented method of claim 8, wherein:
the processor determines whether of not the received audio signal corresponds to music based on the hard and soft decision rules and a voice activity detection (VAD) decision rule;
the state machine comprises a pause state, a speech state, and a music state;
the state machine transitions toward or away from the pause state based on the processor applying the VAD decision rule to the received audio signal;
the state machine transitions from the speech state toward the music state based on the processor applying the hard decision rule to the first and second metric values; and
the state machine transitions from the music state toward the speech state based on the processor applying the soft decision rule to the first and second metric values.

10. The processor-implemented method of claim 1, wherein:
the processor comprises a music detection module (e.g., 104) that performs steps (a)-(d) for user equipment (e.g., 108) further comprising an echo canceller (e.g., 102) adapted to cancel echo in the received audio signal to generate an outgoing audio signal (e.g., Sout) for the user equipment; and
processing of the received audio signal by the echo canceller is based on whether the music detection module determines that the received audio signal corresponds to music.

11. Apparatus comprising a processor for processing audio signals to determine whether or not the audio signals correspond to music, wherein:
the processor is adapted to identify a plurality of tones corresponding to long-duration spectral peaks in a received audio signal (e.g., Sin);
the processor is adapted to generate a value (e.g., Cn) for a first metric based on number of the identified tones;
the processor is adapted to generate a value (e.g., Dn) for a second metric based on duration of the identified tones; and
the processor is adapted to determine whether or not the received audio signal corresponds to music based on the first and second metric values.

12. The apparatus of claim 11, wherein:
the processor is adapted to transform the received audio signal from a time domain into a frequency domain;
the processor is adapted to identify relatively sharp spectral peaks in the frequency domain;
for each relatively sharp spectral peak,
the processor is adapted to generate an accumulator value (e.g., An[k]) based on duration of the relatively sharp spectral peak;
the processor is adapted to compare the accumulator value to an accumulator threshold value; and
the processor is adapted to identify the relatively sharp spectral peak as one of the long-duration spectral peaks in the received audio signal, if the accumulator value is greater than the accumulator threshold value.

13. The apparatus of claim 12, wherein the processor is adapted to generate the second metric value as a sum of the accumulator values for the long-duration spectral peaks.

14. The apparatus of claim 13, wherein the processor is adapted to generate the first and second metric values by assigning different weight values (e.g., Wgt[k]) to different long-duration spectral peaks.

15. The apparatus of claim 14, wherein the processor is adapted to assign smaller weight values to lower-frequency long-duration spectral peaks.

16. The apparatus of claim 11, wherein the processor is adapted to determine whether or not the received audio signal corresponds to music based on hard and soft decision rules that are both functions of the first and second metrics.

17. The apparatus of claim 16, wherein:
the first and second metrics define a two-dimensional metric space;
the hard decision rule delineates a music-only region in the two-dimensional metric space comprising substantially only frames of the received audio signal corresponding to music; and
the soft decision rule delineates a speech-only region in the two-dimensional metric space comprising substantially only frames of the received audio signal corresponding to speech.

18. The apparatus of claim 17, wherein:
the processor is adapted to implement a state machine comprising a plurality of states; and
the state machine transitions from a first state to a second state based on the processor applying at least one of the hard and soft decision rules to the first and second metric values.

19. The apparatus of claim 18, wherein:
the processor is adapted to determine whether of not the received audio signal corresponds to music based on the hard and soft decision rules and a voice activity detection (VAD) decision rule;
the state machine comprises a pause state, a speech state, and a music state;
the state machine transitions toward or away from the pause state based on the processor applying the VAD decision rule to the received audio signal;
the state machine transitions from the speech state toward the music state based on the processor applying the hard decision rule to the first and second metric values; and
the state machine transitions from the music state toward the speech state based on the processor applying the soft decision rule to the first and second metric values.

20. The apparatus of claim 11, wherein:
the processor comprises a music detection module (e.g., 104) that determines whether or not the received audio signal corresponds to music for user equipment (e.g., 108) further comprising an echo canceller (e.g., 102) adapted to cancel echo in the received audio signal to generate an outgoing audio signal (e.g., Sout) for the user equipment; and
processing of the received audio signal by the echo canceller is based on whether the music detection module determines that the received audio signal corresponds to music.

21. The apparatus of claim 11, wherein the apparatus is an integrated circuit.
